(19) United States
(12) Patent Application Publication
(10) Pub. No.: US 2023/0222502 A1
(43) Pub. Date: Jul. 13, 2023

(54) SYSTEM AND METHOD FOR CREATING AND ISSUING VIRTUAL TRANSACTION INSTRUMENTS

(71) Applicant: American Express Travel Related Services Company, Inc., New York, NY (US)

(72) Inventor: Anchal Gupta, Scottsdale, AZ (US)

(21) Appl. No.: 17/811,345

(22) Filed: Jul. 8, 2022

Related U.S. Application Data
(63) Continuation of application No. 16/694,155, filed on Nov. 25, 2019, now abandoned.
Application No. 16/694,155 is a continuation of application No. 14/961,511, filed on Dec. 7, 2015, now abandoned.

(51) Int. Cl. G06Q 20/40; G06Q 20/38

(52) U.S. Cl. CPC G06Q 20/401; G06Q 20/389; G06Q 20/405

(57) ABSTRACT

A virtual transaction account may be issued to a designated recipient, wherein authorization limits may limit the duration, availability, value, and functionality of the virtual transaction account. The virtual transaction account may be linked and depend from a parent transaction account, and contain similar payment functionalities as a credit card. The virtual transaction account may be unilaterally issued by a program administrator, without the need to request issuance from an issuer.

### FIELD

The present disclosure relates to systems and methods for creating and issuing virtual transaction account, and more specifically, issuing virtual sub-transaction accounts linked to a parent transaction account.

### BACKGROUND

Typically, administrators of a transaction account may not unilaterally issue a transaction instrument linked to their transaction account. Instead, the administrator may request from the credit issuing agency a transaction instrument linked to their transaction account. This cumbersome process typically only allows the administrator to request physical credit cards, and does not allow the administrator to request linked transaction accounts having limited purposes, functionalities, and duration.

Moreover, a transaction account issuer issues a transaction account to an account holder. If the account holder wants to give another person access to the account, the account holder can send a request to the issuer to issue another transaction account linked to that account. The process of requesting a sub-transaction account and waiting for the linked transaction account to issue from the issuer can be time consuming. Moreover, the linked transaction account generally does not have any limitations or boundaries, and for all purposes is the same as the originally issued parent transaction account. This may be problematic in various contexts, where more freedom and control are desired over the execution and issuance of sub-transaction accounts.

In the corporate context, it may be desirable to have the freedom to quickly issue sub-transaction accounts, and have control over the execution of those sub-transaction accounts. An entity may desire to issue a sub-transaction account to a contractor or an employee, for a limited purpose and for a limited amount. For example, an employee may be on business-related travel, and the entity may wish to pay for the employee's rental car, hotel, or other miscellaneous travel expense. In this regard, travel-related expenses can become expensive, and situations may arise where the employee is unable to pay for the expenses himself. The entity may also issue a transaction account linked to the entity's parent transaction account, and provide that account to the employee. However, issuing a new transaction account to an employee may not be desirable. For example, the entity may wish to have some control over the items that the employee purchases with the transaction account. The entity may also establish spending limits for the employee, set time limits for when the account can be used, set geographic limitation on where the account can be used, and/or the like. Moreover, in situations where the employee is an independent contractor, the entity may not wish to give the contractor a full and/or corporate transaction account.

### SUMMARY

In various embodiments, systems, methods, and articles of manufacture (collectively the “system”) for issuing virtual transaction accounts are disclosed. In various embodiments, the system may be in electronic communication with a subscriber database. The system may receive a request to issue a virtual transaction account. The request may be input by a program administrator, associated with a parent transaction account, specify a designed recipient, and have an authorization limit for the virtual transaction account. The system may generate the virtual transaction account. The virtual transaction account may be associated with the parent transaction account, for the designated recipient, and have the authorization limit. The system may transmit the virtual transaction account to a mobile application. The mobile application may be linked to the designated recipient.

In various embodiments, the authorization limit may comprise at least one of a pre-authorized start date, a pre-authorized end date, a pre-authorized amount, a pre-authorized use, or a geographical limitation.

In various embodiments, a mobile application may receive the virtual transaction account. The mobile application may send the virtual transaction account to a mobile wallet.

The system may receive a notification in response to the designated recipient having used the virtual transaction account. The system may reconcile the use of the virtual transaction account with the parent transaction account. The system may generate a transaction report based upon the usage of the virtual transaction account.

The foregoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may be obtained by referring to the detailed description and claims when considered in connection with the drawing figures, wherein like numerals denote like elements.

FIG. 1 is a block diagram illustrating various system components of a system for issuing virtual transaction accounts, in accordance with various embodiments;

FIG. 2A illustrates a process flow for initializing a request to send a virtual transaction account, in accordance with various embodiments;

FIG. 2B illustrates a method of initializing a request to send a virtual transaction account, in accordance with various embodiments;

FIG. 3 illustrates a process flow for generating a virtual transaction account, in accordance with various embodiments;

FIG. 4 illustrates a process flow for accessing and using a virtual transaction account, in accordance with various embodiments;

FIG. 5A illustrates a method of accessing a virtual transaction account, in accordance with various embodiments;

FIG. 5B illustrates a method of accessing and using a virtual transaction account, in accordance with various embodiments; and

FIG. 5C illustrates a method for viewing virtual transaction account spending history, in accordance with various embodiments.

### DETAILED DESCRIPTION

The detailed description of exemplary embodiments herein makes reference to the accompanying drawings and pictures, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

In various embodiments, the system may enable an entity to unilaterally issue a virtual transaction account that is linked to the parent transaction account associated with that entity, without having to request and wait for the issuer to issue a new transaction account. In this regard, the system provides the entity with the ability to essentially act as the issuer itself. Instead of having to make a request to the issuer to issue a new transaction account, the entity may itself issue the new transaction account.

In various embodiments, the virtual transaction account may function as a “sub-transaction account” that is linked and associated with the parent transaction account. The virtual transaction account may include limited functionality and certain characteristics. The virtual transaction account may also function similar to an existing transaction account or physical transaction card. In this regard, the virtual transaction account may not be similar to a pre-paid gift card, or other such pre-paid method of payment. Instead, the virtual transaction account may function like a credit card, using the same line of credit as the parent transaction account, with payment on purchases due post-purchase to the issuer.

In various embodiments, the entity may appoint a program administrator to oversee the issuance of the virtual transaction accounts. The program administrator may comprise the individual(s) responsible for generating virtual transaction accounts. In various embodiments, the program administrator may access the system and unilaterally issue a virtual transaction account. The program administrator may also select authorization limits to limit the virtual transaction account. The program administrator may select a designated recipient to receive the virtual transaction account. In this regard, the virtual transaction account may be unilaterally issued using the issuer's preexisting banking network, but without requiring that the entity make a request to the agency to issue a new transaction account.

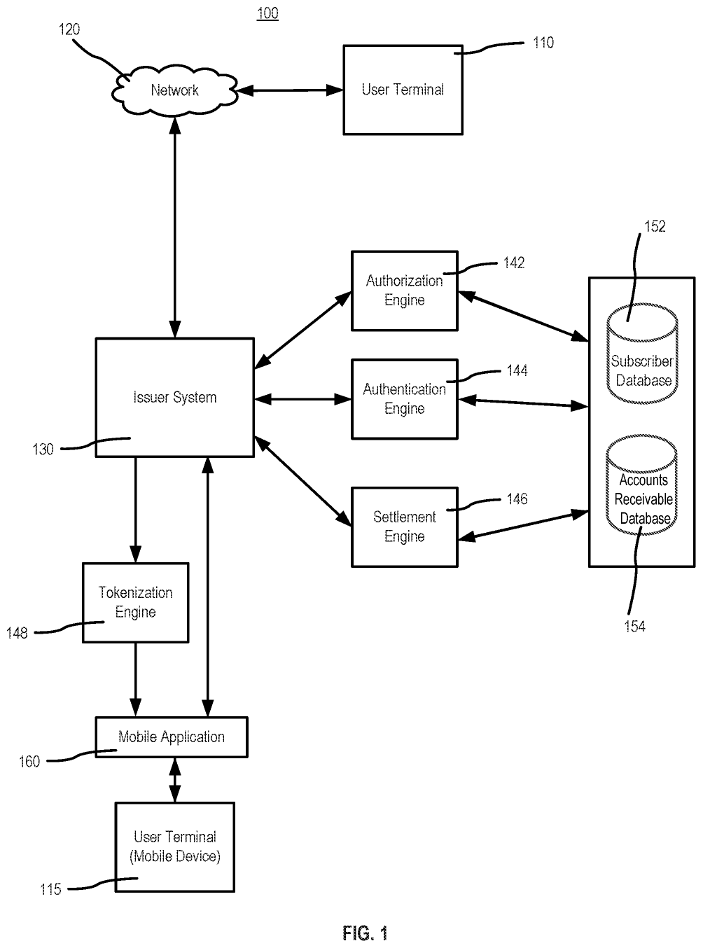

In various embodiments, and with reference to FIG. 1, system 100 may comprise a user terminal 110, a network 120, an issuer system 130, an authorization engine 142, an authentication engine 144, a settlement engine 146, a tokenization engine 148, a subscriber database 152, an accounts receivable database 154, a mobile application 160, and a user terminal 115.

In various embodiments, user terminal 110 may be configured to allow a program administrator, and/or any other suitable entity, access to a networked system. In various embodiments, user terminal 110 may comprise any suitable type of computer-based system disclosed herein or known in the art. User terminal 110 may be in electronic and/or operative communication with network 120. User terminal 110 may be in electronic and/or operative communication using any suitable method discussed herein or known in the art.

In various embodiments, network 120 may be configured to operatively connect user terminal 110 to issuer system 130. Network 120 may comprise any suitable type of network, including those networks described herein. Network 120 may be in operative and/or electronic communication with user terminal 110 and/or issuer system 130. Network 120 may be in electronic and/or operative communication using any suitable method discussed herein or known in the art.

In various embodiments, issuer system 130 may be configured as a central hub to access various engines and systems of a banking infrastructure. In this regard, issuer system 130 may comprise a network and/or computer-based system configured to provide an access point to various components of a banking system. Issuer system 130 may be in operative and/or electronic communication with network 120, authorization engine 142, authentication engine 144, settlement engine 146, tokenization engine 148, and/or mobile application 160. Issuer system 130 may be in electronic and/or operative communication using any suitable method discussed herein or known in the art.

In various embodiments, authorization engine 142 may be configured to check authorization for a program administrator, or other similar entity, to determine whether program administrator may issue a virtual transaction account. In this regard, authorization engine 142 may parse data from issuer system 130, and communicate with databases (e.g., subscriber database 152 and accounts receivable database 154) to determine whether to authorize a request to issue a virtual transaction account. Authorization engine 142 may be in electronic and/or operative communication with issuer system 130, subscriber database 152, and/or accounts receivable database 154. Authorization engine 142 may be in electronic and/or operative communication using any suitable method discussed herein or known in the art.

In various embodiments, authentication engine 144 may be configured to check credentials of a program administrator. Authentication engine 144 may be configured to receive credentials of the program administrator from issuer system 130, and match those credentials against entries in the subscriber database 152. In this regard, authentication engine 144 may provide a mechanism for authenticating a user. Authentication engine 144 may be in electronic and/or operative communication with issuer system 130, subscriber database 152, and/or accounts receivable database 154. Authentication engine 144 may be in electronic and/or operative communication using any suitable method discussed herein or known in the art.

In various embodiments, settlement engine 146 may be configured to process payment information and may subsequently transmit a transaction confirmation notifying a merchant of a successful payment transaction. Settlement engine 146 may process payment information by communicating with accounts receivable database 154 to recall data on a stored transaction account. Settlement engine 146 may be in electronic and/or operative communication with issuer system 130, subscriber database 152, and/or accounts receivable database 154. Settlement engine may be in electronic and/or operative communication using any suitable method.

In various embodiments, tokenization engine 148 may be configured to generate a virtual transaction account and send the virtual transaction account to a mobile application 160. In this regard, tokenization engine 148 may receive data from issuer system 130 to generate the virtual transaction account, and may send the generated virtual transaction account to mobile application 160. Tokenization engine 148 may generate the virtual transaction account as a virtual token, which may then be used as a virtual payment mechanism compatible with mobile wallets and/or the like. Generating the virtual transaction account as a token may allow the virtual transaction account to be stored in a mobile wallet such as Apple Pay™, Android Pay™, and/or Google Wallet™. Tokenization engine 148 may be in electronic and/or operative communication with issuer system 130 and/or mobile application 160. Tokenization engine 148 may be in electronic and/or operative communication using any suitable method.

In various embodiments, subscriber database 152 may be configured to contain data. In this regard, subscriber database 152 may be configured to contain data related to transaction account subscribers. Subscriber database 152 may comprise data on user accounts linked to transaction account subscribers, including for example, data on user IDs, passwords, and/or other such data relating to transaction account information. Subscriber database 152 may be in electronic and/or operative communication with authorization engine 142, authentication engine 144, and/or settlement engine 146. Subscriber database 152 may be in electronic and/or operative communication using any suitable method.

In various embodiments, accounts receivable database 154 may be configured to contain data. In this regard, accounts receivable database 154 may comprise data relating to transaction account subscriber accounts, such as, for example, transaction account ID, transaction history, pending transactions, and/or the like. Accounts receivable database 152 may be in electronic and/or operative communication with authorization engine 142, authentication engine 144, and/or settlement engine 146. Accounts receivable database 152 may be in electronic and/or operative communication using any suitable method.

In various embodiments, mobile application 160 may be configured to receive virtual transaction account. In this regard, mobile application 160 may receive the virtual transaction account from tokenization engine 148. A designated recipient, or any other such suitable entity, may then access mobile application 160 to view and use the virtual transaction account. Mobile application 160 may be linked to the designated recipient, such that only the designated recipient may be able to access mobile application 160 to retrieve the generated virtual transaction account. Mobile application 160 may be in electronic and/or operative communication with tokenization engine 148, issuer system 130, and/or user terminal 115. Mobile application 160 may be in electronic and/or operative communication using any suitable method.

In various embodiments, user terminal 115 may be configured to access mobile application 160. In this regard, mobile application 160 may reside on user terminal 115. For example, mobile application 160 may comprise an app installed on a mobile device, such as a smartphone. In various embodiments, mobile application 160 may be located on a server, such as in cloud storage, and user terminal 115 may remotely access mobile application 160. User terminal 115 may be in operative and/or electronic communication with mobile application 160. User terminal 115 may be in electronic and/or operative communication using any suitable method.

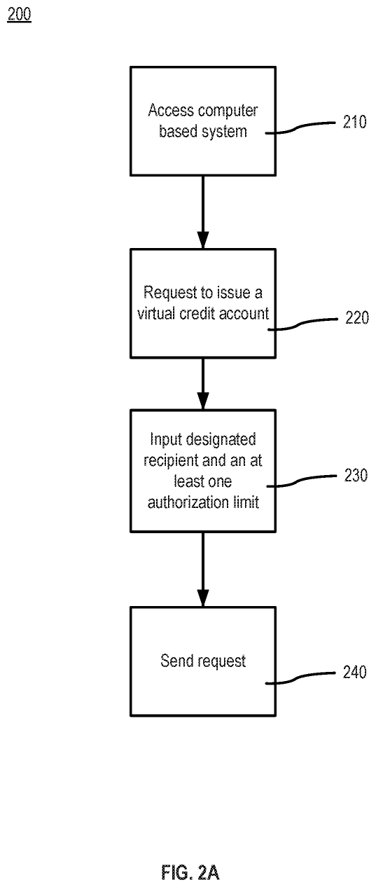

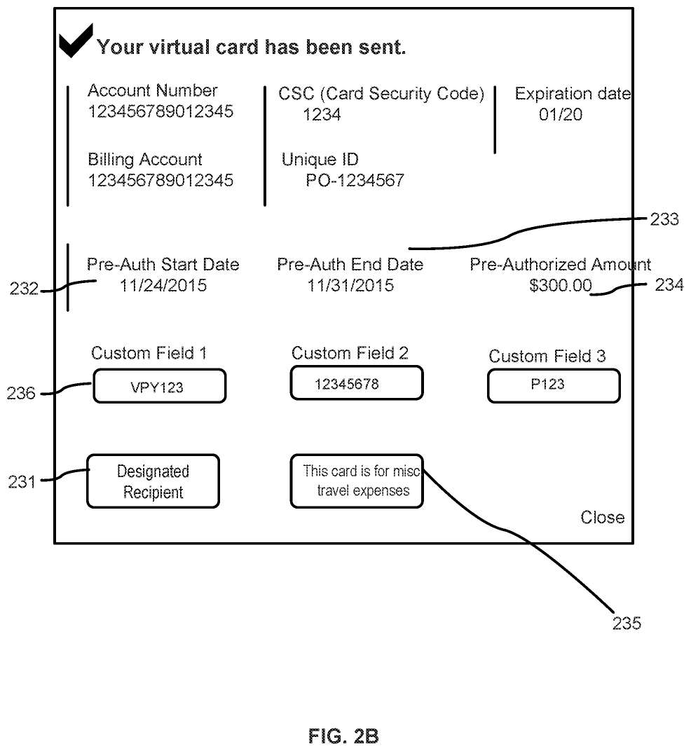

In various embodiments, and with reference to FIG. 2, a method 200 for generating a virtual transaction account is disclosed. The virtual transaction account may be generated by a program administrator. Method 200 may comprise accessing a computer-based system 210 by using a user terminal 110 connected to a network 120. Connecting through network 120, the program administrator may access an issuer system 130. In various embodiments, program administrator may access issuer system 130 through a user login. In this regard, logging on to issuer system 130 would give the program administrator access to information related to the parent transaction account. User login may comprise any suitable type of secure login. For example, user login may require a user ID and password. User login may also comprise biometric access, and/or any other suitable type of secure login.

In various embodiments, data on the user login may be sent to an authentication engine 144. Authentication engine 144 may parse data on the user login and check for matching data in a subscriber database 152. Subscriber database 152 may comprise data linking a parent transaction account to a user login. In response to the data on the user login matching a user login stored in subscriber database 152, authentication engine 142 may send to issuer system 130 data on the parent transaction account to enable the program administrator to successfully login to issuer system 130.

In various embodiments, method 200 may comprise a request to issue a virtual transaction account 220. In this regard, a program administrator may submit a request to issue a virtual transaction account to a designated recipient. Program administrator may make the request through the issuer system 130. In response to the request from program administrator, issuer system 130 may communicate with the authorization engine 142. Issuer system 130 may communicate with authorization engine 142 to check whether program administrator is authorized to request a virtual transaction account. Authorization engine 142 may operatively communicate with subscriber database 152 and accounts receivable database 154 to gather data relating to the parent transaction account. Authorization engine 142 may operatively communicate with subscriber database 152 to check whether parent transaction account is authorized to issue virtual transaction accounts. Authorization engine 142 may operatively communicate with accounts receivable database 154 to check whether parent transaction account has necessary funds and/or line of credit to issue a virtual transaction account. In response to authorization engine 142 authorizing program administrator's request to issue a virtual transaction account 220, issuer system 130 may grant program administrator's request, and allow program administrator access to issue a virtual transaction account.

In various embodiments, method 200 may comprise inputting a designated recipient and an authorization limit 230. In various embodiments, and with reference to FIG. 2B, a designated recipient 231 may be any entity and/or individual that program administrator wishes to issue a virtual transaction account to. For example, designated recipient 231 may be an employee or independent contractor. Designated recipient 231 may comprise an entity working together with the program administrator. Designated recipient 231 may comprise any suitable and/or desirable recipient.

In various embodiments, an authorization limit may be configured to limit the use of the virtual transaction account. An authorization limit may comprise a pre-authorized start date 232, a pre-authorized end date 233, a pre-authorized amount 234, a pre-authorized use 235, and/or a geographical limitation. Authorization limit may also comprise any other suitable limitation on use of a transaction account. In various embodiments, program administrator may select as many authorization limits as is desired. Program administrator may also enter in and create new authorization limits in custom fields 236, as is desired.

Pre-authorized start date 232 may comprise the date that the virtual transaction account is active for designated recipient 231 to use. In this regard, pre-authorized start date 232 may be the date that the virtual transaction account is sent, or it may be a date in the future, after the virtual transaction account is sent. Pre-authorized end date 233 may comprise the date that the virtual transaction account is active to use. For example, if the program administrator wanted the virtual transaction account to only be active during a one-week business trip, the program administrator could set pre-authorized end date 233 to be a week after pre-authorized start date 232.

Pre-authorized amount 234 may comprise the monetary value of the virtual transaction account. Pre-authorized amount 234 may comprise any suitable monetary value, and in any suitable currency. In this regard, pre-authorized amount 234 may be used to restrict the amount of money that a designated recipient 231 is authorized to spend. Pre-authorized amount 234 may also be a specific monetary amount, used to either reimburse designated recipient 231 or to pay for a specific, pre-determined amount.

Pre-authorized use 235 may comprise the limited use assigned to the virtual transaction account. For example, program administrator may wish to issue the virtual transaction account to pay for designated recipient's 231 rental car. In this regard, program administrator may limit the use of the virtual card to a specified rental car company, such as Hertz®, Alamo®, Budget®, and/or the like. Similarly, program administrator may desire to limit the use to a hotel, grocery store, shopping center, a category of items, a geographic location and/or for any other similar or desired use. Pre-authorized use 235 may be any suitable and/or desired use assigned to the virtual transaction account. In response to designated recipient 231 attempting to use the virtual transaction account for a use outside of pre-authorized use 235, the transaction may be denied. In this regard, pre-authorized use 235 may be used as a mechanism to control the designated recipient's usage of the virtual transaction account.

Geographical limitation may comprise a limited geographical use assigned to the virtual transaction account, and may be used to further limit the virtual transaction account. For example, program administrator may wish to limit the geographical use of the virtual transaction account to the geographical area in which designated recipient 231 is traveling. For example, in response to designated recipient 231 traveling to Phoenix, Ariz., program administrator may wish to set the geographical limitation to Phoenix, AZ. In response to designated recipient 231 traveling throughout the Southwest United States, program administrator may wish to set the geographical limitation to New Mexico, Arizona, Texas, and/or any other desired states. In response to designated recipient 231 traveling in Europe, program administrator may wish to set geographical limitation to be a specific country, such as Germany, Spain, Italy, etc. In response to designated recipient 231 attempting to use the virtual transaction account outside of the geographical limitation, the transaction may be denied. In this regard, geographical limitation may be used as a mechanism to further control the designated recipient's usage of the virtual transaction account.

In various embodiments, method 200 may comprise sending the request to issue a virtual transaction account 240. In this regard, program administrator may send the request from user terminal 110 along with selections of designated recipient 231 and authorization limits. The request may be sent from user terminal 110 through network 120, and to issuer system 130. The request may be associated and/or linked with the parent transaction account, and may contain the designated recipient 231 and the authorization limits for the virtual transaction account.

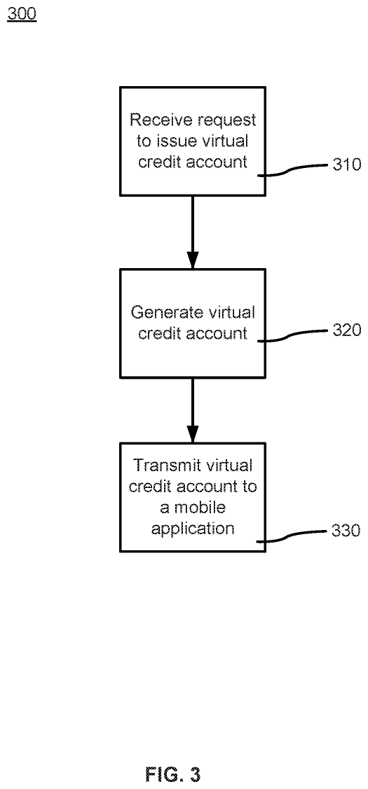

In various embodiments, and with reference to FIG. 3, a method 300 for generating a virtual transaction account is disclosed. Method 300 may comprise issuer system 130 receiving a request from user terminal 110 to issue virtual transaction account 310. The request may include the parent transaction account information, so the request may be associated/linked with the parent transaction account. The request may also contain the designated recipient and the authorization limits selected for the virtual transaction account.

In various embodiments, method 300 may comprise generating the virtual transaction account 320. In response to receiving the request to issue virtual transaction account 310, issuer system 130 may generate virtual transaction account 320. Issuer system 130 may operatively communicate with tokenization engine 148 to generate the virtual transaction account. Tokenization engine 148 may receive the request from issuer system 130, and generate a virtual transaction account. The generated virtual transaction account may be associated with the parent transaction account, and may contain the designated recipient and the authorization limits for the virtual transaction account.

In various embodiments, tokenization engine 148 may transmit the generated virtual transaction account to a mobile application 160. Mobile application 160 may be linked to the designated recipient. Mobile application 160 may be linked to the designated recipient through the use of a security login, or other such type of identifying data. Mobile application 160 may identify and link designated recipient based on a user ID and password, a biometric measure, such as through the use of a fingerprint reader, and/or through any other suitable method of identification. Data linking the designated recipient to mobile application 160 may be stored in subscriber database 152.

Tokenization engine 148 may then transmit the generated transaction account to mobile application 160 linked to the specified designated recipient. Tokenization engine 148 may operatively communicate with issuer system 130 to determine mobile application 160 linked to the designated recipient. Issuer system 130 may operatively communicate with authentication engine 144, which may operatively communicate with subscriber database 152 to gather data on the mobile application 160 linked to the designated recipient. Issuer system 130 may then return that data to tokenization engine 148, and tokenization engine 148 may then transmit the virtual transaction account to mobile application 160. Upon transmitting the virtual transaction account, designated recipient may receive notification prompting to download and/or install mobile application 160. In various embodiments, designated recipient may already have mobile application 160 downloaded and/or installed, and in response to transmitting the virtual transaction account, designated recipient may receive notification that a virtual transaction account has been transmitted.

In various embodiments, mobile application 160 may further transmit the virtual transaction account to a mobile wallet. In this regard, mobile application 160 may receive virtual transaction account, reformat the data, and retransmit the virtual transaction account to the mobile wallet. In various embodiments, mobile application 160 may comprise a mobile wallet. In this regard, the virtual transaction account may be transmitted directly to the mobile wallet (mobile application 160), and needs no re-transmission. In embodiments where mobile application 160 comprises a mobile wallet, mobile wallet may also be transmitted to a mobile wallet hub containing multiple mobile wallets.

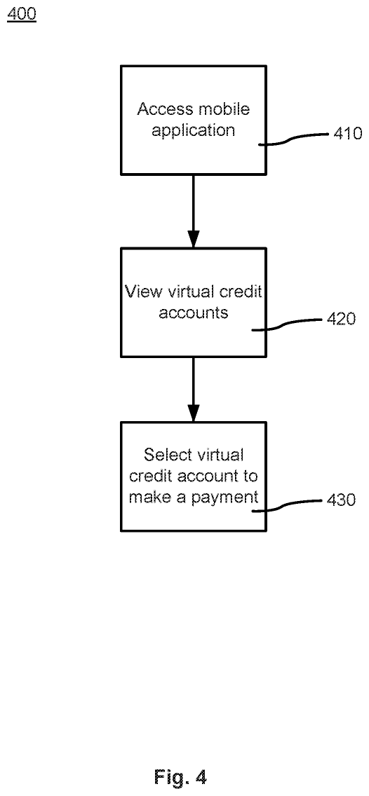

In various embodiments, and with reference to FIG. 4, a method 400 for accessing and using a virtual transaction account is disclosed. Method 400 may comprise accessing a mobile application 410. The designated recipient may access the mobile application 160 through a user terminal 115. User terminal 115 may have mobile application 160 downloaded and/or installed on user terminal 115. In various embodiments, user terminal 115 may also access mobile application 160 through a network, wherein mobile application 160 resides on a server and/or a separate user terminal.

In various embodiments, designated recipient may access mobile application 160 through the use of a security login. Mobile application 160 may identify designated recipient based on a user ID and password, a biometric measure, such as through the use of a fingerprint reader, and/or any other suitable method of identification. The security login may be linked to the designated recipient. In response to the designated recipient entering the security login, mobile application 160 may grant the designated recipient access to the virtual transaction accounts transmitted and linked to his account.

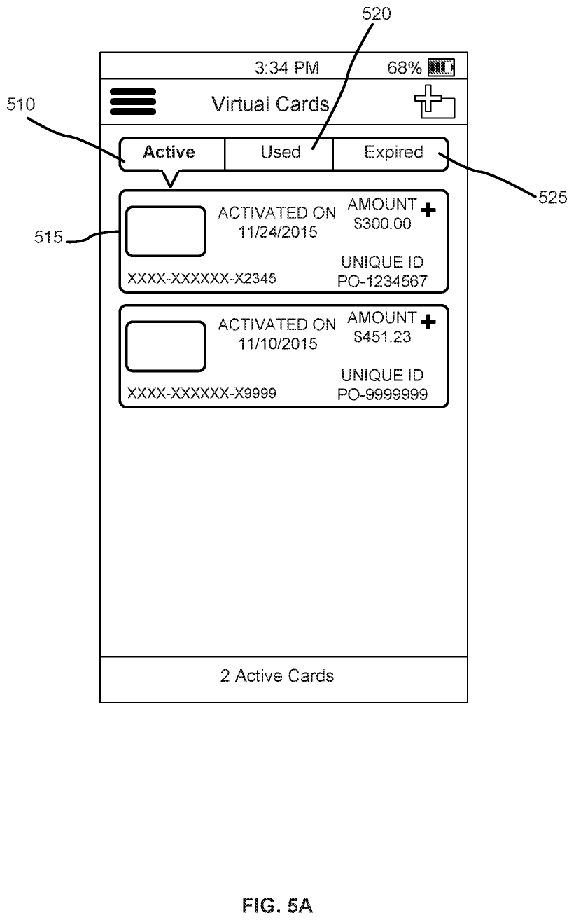

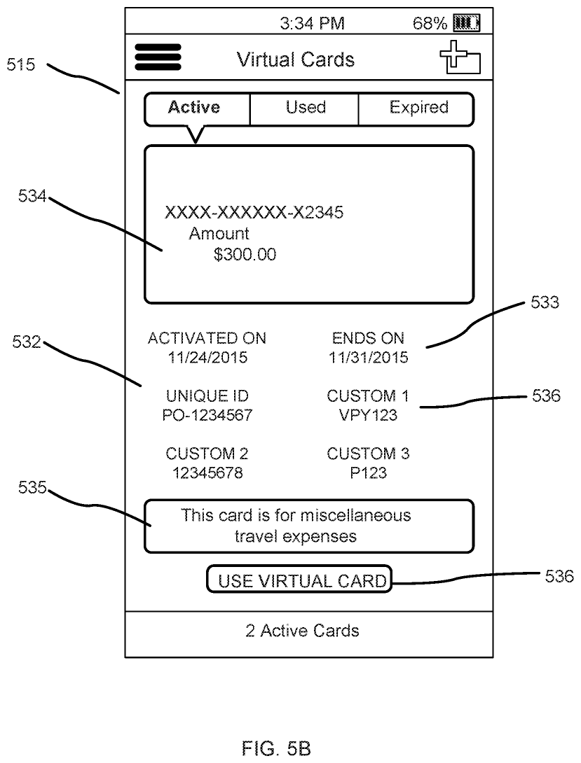

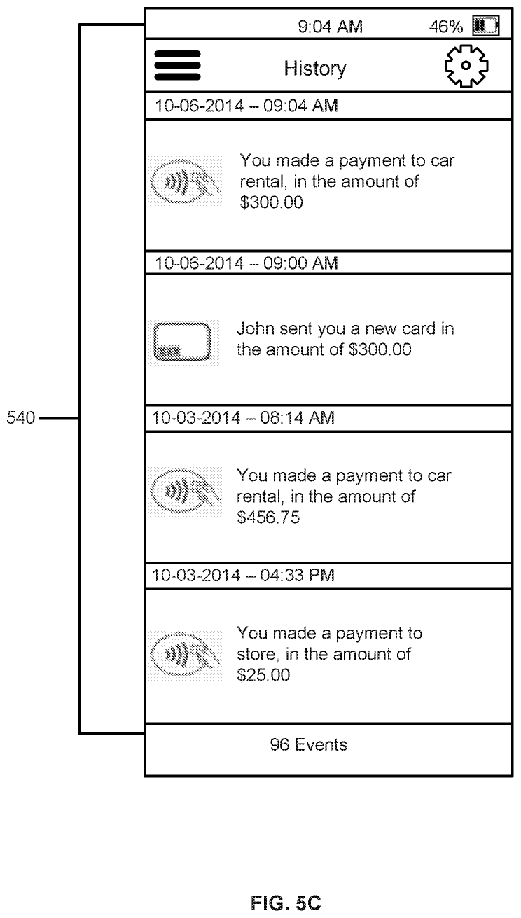

In various embodiments, method 400 may comprise viewing virtual transaction accounts 420. Designated recipient may view virtual transaction accounts transmitted to him, via the mobile application 160. In various embodiments, and with reference to FIG. 5A, designated recipient may view active 510, used 520, and/or expired 525 virtual transaction accounts. Active virtual transaction accounts 510 may comprise current virtual transaction accounts 515 linked to the designated recipient that have not been used or expired. Used virtual transaction accounts 520 may comprise virtual transaction accounts linked to the designated recipient that the designated recipient has already used. Expired virtual transaction accounts 525 may comprise virtual transaction accounts that were not used by the designated recipient, but on which the pre-authorized end date has already passed.

In various embodiments, method 400 may comprise selecting the virtual transaction account to make a payment 430. Designated recipient may use mobile application 160 to select an active virtual transaction account to make a payment. Virtual transaction account may have the same authorization limits as those designated by program administrator during the generation of the virtual transaction account. For example, and in reference to FIG. 5B, authorization limit of virtual transaction account 515 may comprise pre-authorized start date 532, pre-authorized end date 533, pre-authorized amount 534, pre-authorized use 535, and/or geographical limitation. Authorization limit of virtual transaction account 515 may also comprise custom fields 536 created by the program administrator during generation of virtual transaction account 515. Designated recipient may select virtual transaction account 515 and use virtual transaction account 515 to make the payment.

In various embodiments, and in response to the designated recipient selecting a virtual transaction account to make a payment 430, mobile application 160 may operatively communicate with issuer system 130 to process and approve the payment. Issuer system 130 may approve the payment by comparing the use of the virtual transaction account to the pre-authorized limitations. In response to the use of the virtual transaction account not matching the pre-authorized limitation (e.g., the virtual transaction account was used in Spain, but the geographical limitation was set to the United States), the issuer system 130 may reject the payment, and operatively communicate that to the mobile application. In response to the use of the virtual transaction account matching the pre-authorized limitation (e.g., the pre-authorized use was for rental cars, and the virtual transaction account was used to rent a car), the issuer system 130 may approve the payment. Issuer system 130 may determine the use of the virtual transaction account by viewing a merchant code associated with the payment. The merchant code may be linked to the merchant that the designated recipient is attempting to pay. The merchant code may contain data relating to the merchant. For example, the merchant code may contain data regarding merchant geographical location (e.g., United States, Texas, etc.), merchant type of business (e.g., car rental business, grocery business, etc.), and/or other similar type data.

Issuer system 130 may operatively communicate with settlement engine 146 to process and approve the transaction. Settlement engine 146 may operatively communicate with accounts receivable database 154 and subscriber database 152. Settlement engine 146 may reconcile the use of virtual transaction account with the credit line associated with the parent transaction account. For example, if the pre-authorized amount for the virtual transaction account was $300.00, and $300.00 of the virtual transaction account was used in the transaction, settlement engine 146 would apply the $300.00 transaction to the account associated with the parent transaction account.

In various embodiments, and in response to settlement engine 146 reconciling and approving the virtual transaction account transaction, settlement engine 146 may operatively communicate with issuer system 130 to approve the transaction. In response to approval of the transaction by settlement engine 146, issuer system may operatively communicate with mobile application 160 to approve the transaction. Mobile application 160 may then release the monetary amount through the transaction.

In various embodiments, and with reference to FIG. 5C, a transaction report 540 based upon the usage of the virtual transaction account may be generated. Transaction report 540 may be generated by issuer system 130. Issuer system 130 may operatively communicate with settlement engine 146. Settlement engine 146 may operatively communicate with subscriber database 152 and accounts receivable database 154 to retrieve data regarding the use of virtual transaction accounts. Issuer system 130 may parse the data, and group the use of virtual transaction accounts by designated beneficiary, by parent transaction account, and/or by any other suitable grouping. The grouped data may then be formatted by issuer system 130 into transaction report 540.

In various embodiments, transaction report 540 relating to designated beneficiary may be sent from issuer system 130 to mobile application 160. Designated beneficiary may access mobile application, and view transaction report 540. Transaction report 540 may comprise details and data regarding use and requests of virtual transaction accounts. In various embodiments, transaction report 540 relating to parent transaction account may be viewed by program administrator. In this regard, program administrator may access issuer system 130, through any method described herein, and may view the transaction report 540 therein.

Systems, methods and computer program products are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

As used herein, “match” or “associated with” or similar phrases may include an identical match, a partial match, meeting certain criteria, matching a subset of data, a correlation, satisfying certain criteria, a correspondence, an association, an algorithmic relationship and/or the like. Similarly, as used herein, “authenticate” or similar terms may include an exact authentication, a partial authentication, authenticating a subset of data, a correspondence, satisfying certain criteria, an association, an algorithmic relationship and/or the like.

The phrases consumer, customer, user, account holder, account affiliate, cardmember or the like shall include any person, entity, business, government organization, business, software, hardware, machine associated with a transaction account, buys merchant offerings offered by one or more merchants using the account and/or who is legally designated for performing transactions on the account, regardless of whether a physical card is associated with the account. For example, the cardmember may include a transaction account owner, a transaction account user, an account affiliate, a child account user, a subsidiary account user, a beneficiary of an account, a custodian of an account, and/or any other person or entity affiliated or associated with a transaction account.

As used herein, big data may refer to partially or fully structured, semi-structured, or unstructured data sets including millions of rows and hundreds of thousands of columns. A big data set may be compiled, for example, from a history of purchase transactions over time, from web registrations, from social media, from records of charge (ROC), from summaries of charges (SOC), from internal data, or from other suitable sources. Big data sets may be compiled without descriptive metadata such as column types, counts, percentiles, or other interpretive-aid data points.

A record of charge (or “ROC”) may comprise any transaction or transaction data. The ROC may be a unique identifier associated with a transaction. A transaction may, in various embodiments, be performed by a one or more members using a transaction account, such as a transaction account associated with a gift card, a debit card, a credit card, and the like. A ROC may, in addition, contain details such as location, merchant name or identifier, transaction amount, transaction date, account number, account security pin or code, account expiry date, and the like for the transaction.

Any communication, transmission and/or channel discussed herein may include any system or method for delivering content (e.g. data, information, metadata, etc), and/or the content itself. The content may be presented in any form or medium, and in various embodiments, the content may be delivered electronically and/or capable of being presented electronically. For example, a channel may comprise a website or device (e.g., Facebook, YOUTUBE®, APPLE®TV®, PANDORA®, XBOX®, SONY® PLAYSTATION®), a uniform resource locator (“URL”), a document (e.g., a MICROSOFT® Word® document, a MICROSOFT® Excel® document, an ADOBE® .pdf document, etc.), an “ebook,” an “emagazine,” an application or microapplication (as described herein), an SMS or other type of text message, an email, facebook, twitter, MMS and/or other type of communication technology. In various embodiments, a channel may be hosted or provided by a data partner. In various embodiments, the distribution channel may comprise at least one of a merchant website, a social media website, affiliate or partner websites, an external vendor, a mobile device communication, social media network and/or location based service. Distribution channels may include at least one of a merchant website, a social media site, affiliate or partner websites, an external vendor, and a mobile device communication. Examples of social media sites include FACEBOOK®, FOURSQUARE®, TWITTER®, MYSPACE®, LINKEDIN®, and the like. Examples of affiliate or partner websites include AMERICAN EXPRESS®, GROUPON®, LIVINGSOCIAL®, and the like. Moreover, examples of mobile device communications include texting, email, and mobile applications for smartphones.

In various embodiments, the methods described herein are implemented using the various particular machines described herein. The methods described herein may be implemented using the herein particular machines, and those hereinafter developed, in any suitable combination, as would be appreciated immediately by one skilled in the art. Further, as is unambiguous from this disclosure, the methods described herein may result in various transformations of certain articles.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., WINDOWS® NT®, WINDOWS® 95/98/2000®, WINDOWS® XP®, WINDOWS® Vista®, WINDOWS® 7®, OS2, UNIX®, LINUX®, SOLARIS° , MacOS, etc.) as well as various conventional support software and drivers typically associated with computers.

The present system or any part(s) or function(s) thereof may be implemented using hardware, software or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations. Useful machines for performing the various embodiments include general purpose digital computers or similar devices.

In fact, in various embodiments, the embodiments are directed toward one or more computer systems capable of carrying out the functionality described herein. The computer system includes one or more processors, such as processor. The processor is connected to a communication infrastructure (e.g., a communications bus, cross over bar, or network). Various software embodiments are described in terms of this exemplary computer system. After reading this description, it will become apparent to a person skilled in the relevant art(s) how to implement various embodiments using other computer systems and/or architectures. Computer system can include a display interface that forwards graphics, text, and other data from the communication infrastructure (or from a frame buffer not shown) for display on a display unit.

Computer system also includes a main memory, such as for example random access memory (RAM), and may also include a secondary memory. The secondary memory may include, for example, a hard disk drive and/or a removable storage drive, representing a floppy disk drive, a magnetic tape drive, an optical disk drive, etc. The removable storage drive reads from and/or writes to a removable storage unit in a well-known manner. Removable storage unit represents a floppy disk, magnetic tape, optical disk, etc. which is read by and written to by removable storage drive . As will be appreciated, the removable storage unit includes a computer usable storage medium having stored therein computer software and/or data.

In various embodiments, secondary memory may include other similar devices for allowing computer programs or other instructions to be loaded into computer system. Such devices may include, for example, a removable storage unit and an interface. Examples of such may include a program cartridge and cartridge interface (such as that found in video game devices), a removable memory chip (such as an erasable programmable read only memory (EPROM), or programmable read only memory (PROM)) and associated socket, and other removable storage units and interfaces, which allow software and data to be transferred from the removable storage unit to computer system.

Computer system may also include a communications interface. Communications interface allows software and data to be transferred between computer system and external devices. Examples of communications interface may include a modem, a network interface (such as an Ethernet card), a communications port, a Personal Computer Memory Card International Association (PCMCIA) slot and card, etc. Software and data transferred via communications interface are in the form of signals which may be electronic, electromagnetic, optical and/or other signals capable of being received by communications interface. These signals are provided to communications interface via a communications path (e.g., channel). This channel carries signals and may be implemented using wire, cable, fiber optics, a telephone line, a cellular link, a radio frequency (RF) link, wireless and other communications channels.

The terms “computer program medium” and “computer usable medium” and “computer readable medium” are used to generally refer to media such as removable storage drive and a hard disk installed in hard disk drive. These computer program products provide software to computer system.

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

In various embodiments, software may be stored in a computer program product and loaded into computer system using removable storage drive, hard disk drive or communications interface. The control logic (software), when executed by the processor, causes the processor to perform the functions of various embodiments as described herein. In various embodiments, hardware components such as application specific integrated circuits (ASICs). Implementation of the hardware state machine so as to perform the functions described herein will be apparent to persons skilled in the relevant art(s).

In various embodiments, the server may include application servers (e.g. WEB SPHERE, WEB LOGIC, JBOSS). In various embodiments, the server may include web servers (e.g. APACHE, IIS, GWS, SUN JAVA® SYSTEM WEB SERVER).

A web client includes any device (e.g., personal computer) which communicates via any network, for example such as those discussed herein. Such browser applications comprise Internet browsing software installed within a computing unit or a system to conduct online transactions and/or communications. These computing units or systems may take the form of a computer or set of computers, although other types of computing units or systems may be used, including laptops, notebooks, tablets, hand held computers, personal digital assistants, set-top boxes, workstations, computer-servers, main frame computers, mini-computers, PC servers, pervasive computers, network sets of computers, personal computers, such as IPADS®, IMACS®, and MACBOOKS®, kiosks, terminals, point of sale (POS) devices and/or terminals, televisions, or any other device capable of receiving data over a network. A web-client may run MICROSOFT® INTERNET EXPLORER®, MOZILLA® FIREFOX®, GOOGLE® CHROME®, APPLE® Safari, or any other of the myriad software packages available for browsing the internet.

Practitioners will appreciate that a web client may or may not be in direct contact with an application server. For example, a web client may access the services of an application server through another server and/or hardware component, which may have a direct or indirect connection to an Internet server. For example, a web client may communicate with an application server via a load balancer. In various embodiments, access is through a network or the Internet through a commercially-available web-browser software package.

As those skilled in the art will appreciate, a web client includes an operating system (e.g., WINDOWS® OS, UNIX® OS, LINUX® OS, MacOS, and/or the like) as well as various conventional support software and drivers typically associated with computers. A web client may include any suitable personal computer, network computer, workstation, personal digital assistant, cellular phone, smart phone, minicomputer, mainframe or the like. A web client can be in a home or business environment with access to a network. In various embodiments, access is through a network or the Internet through a commercially available web-browser software package. A web client may implement security protocols such as Secure Sockets Layer (SSL) and Transport Layer Security (TLS). A web client may implement several application layer protocols including http, https, ftp, and sftp.

In various embodiments, components, modules, and/or engines of system 100 may be implemented as micro-applications or micro-apps. Micro-apps are typically deployed in the context of a mobile operating system, including for example, a WINDOWS® mobile operating system, an ANDROID® Operating System, APPLE® IOS®, a BLACKBERRY® operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

As used herein an “identifier” may be any suitable identifier that uniquely identifies an item. For example, the identifier may be a globally unique identifier (“GUID”). The GUID may be an identifier created and/or implemented under the universally unique identifier standard. Moreover, the GUID may be stored as 128-bit value that can be displayed as 32 hexadecimal digits. The identifier may also include a major number, and a minor number. The major number and minor number may each be 16 bit integers.

As used herein, the term “network” includes any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., IPHONE®, BLACKBERRY®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, APPLE®talk, IP-6, NetBIOS®, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein.

The various system components may be independently, separately or collectively suitably coupled to the network via data links which includes, for example, a connection to an Internet Service Provider (ISP) over the local loop as is typically used in connection with standard modem communication, cable modem, Dish Networks®, ISDN, Digital Subscriber Line (DSL), or various wireless communication methods. It is noted that the network may be implemented as other types of networks, such as an interactive television (ITV) network. Moreover, the system contemplates the use, sale or distribution of any goods, services or information over any network having similar functionality described herein.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing.

As used herein, “transmit” may include sending electronic data from one system component to another over a network connection. Additionally, as used herein, “data” may include encompassing information such as commands, queries, files, data for storage, and the like in digital or any other form.

As used herein, “issue a debit”, “debit” or “debiting” refers to either causing the debiting of a stored value or prepaid card-type financial account, or causing the charging of a credit or charge card-type financial account, as applicable.

The system contemplates uses in association with web services, utility computing, pervasive and individualized computing, security and identity solutions, autonomic computing, cloud computing, commodity computing, mobility and wireless solutions, open source, biometrics, grid computing and/or mesh computing.

Any databases discussed herein may include relational, hierarchical, graphical, or object-oriented structure and/or any other database configurations. Common database products that may be used to implement the databases include DB2 by IBM® (Armonk, N.Y.), various database products available from ORACLE® Corporation (Redwood Shores, Calif.), MICROSOFT® Access® or MICROSOFT® SQL Server® by MICROSOFT® Corporation (Redmond, Wash.), MySQL by MySQL AB (Uppsala, Sweden), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In various embodiments, the ability to store a wide variety of information in different formats is facilitated by storing the information as a BLOB. Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with the financial transaction instrument by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments, the data can be stored without regard to a common format. However, the data set (e.g., BLOB) may be annotated in a standard manner when provided for manipulating the data onto the financial transaction instrument. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a standalone interaction device configured to add, delete, modify, or augment the data in accordance with the header or trailer. As such, in one embodiment, the header or trailer is not stored on the transaction device along with the associated issuer-owned data but instead the appropriate action may be taken by providing to the transaction instrument user at the stand alone device, the appropriate option for the action to be taken. The system may contemplate a data storage arrangement wherein the header or trailer, or header or trailer history, of the data is stored on the transaction instrument in relation to the appropriate data.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

Encryption may be performed by way of any of the techniques now available in the art or which may become available—e.g., Twofish, RSA, El Gamal, Schorr signature, DSA, PGP, PM, GPG (GnuPG), and symmetric and asymmetric cryptosystems.

The computing unit of the web client may be further equipped with an Internet browser connected to the Internet or an intranet using standard dial-up, cable, DSL or any other Internet protocol known in the art. Transactions originating at a web client may pass through a firewall in order to prevent unauthorized access from users of other networks. Further, additional firewalls may be deployed between the varying components of CMS to further enhance security.

Firewall may include any hardware and/or software suitably configured to protect CMS components and/or enterprise computing resources from users of other networks. Further, a firewall may be configured to limit or restrict access to various systems and components behind the firewall for web clients connecting through a web server. Firewall may reside in varying configurations including Stateful Inspection, Proxy based, access control lists, and Packet Filtering among others. Firewall may be integrated within an web server or any other CMS components or may further reside as a separate entity. A firewall may implement network address translation (“NAT”) and/or network address port translation (“NAPT”). A firewall may accommodate various tunneling protocols to facilitate secure communications, such as those used in virtual private networking. A firewall may implement a demilitarized zone (“DMZ”) to facilitate communications with a public network such as the Internet. A firewall may be integrated as software within an Internet server, any other application server components or may reside within another computing device or may take the form of a standalone hardware component.

The computers discussed herein may provide a suitable website or other Internet-based graphical user interface which is accessible by users. In one embodiment, the MICROSOFT® INTERNET INFORMATION SERVICES® (IIS), MICROSOFT® Transaction Server (MTS), and MICROSOFT® SQL Server, are used in conjunction with the MICROSOFT® operating system, MICROSOFT® web server software, a MICROSOFT® SQL Server database system, and a MICROSOFT® Commerce Server. Additionally, components such as Access or MICROSOFT® SQL Server, ORACLE®, Sybase, Informix MySQL, Interbase, etc., may be used to provide an Active Data Object (ADO) compliant database management system. In one embodiment, the Apache web server is used in conjunction with a Linux operating system, a MySQL database, and the Perl, PHP, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, JAVA® APPLE®ts, JAVASCRIPT, active server pages (ASP), common gateway interface scripts (CGI), extensible markup language (XML), dynamic HTML, cascading style sheets (CSS), AJAX (Asynchronous JAVASCRIPT And XML), helper applications, plug-ins, and the like. A server may include a web service that receives a request from a web server, the request including a URL and an IP address (123.56.789.234). The web server retrieves the appropriate web pages and sends the data or applications for the web pages to the IP address. Web services are applications that are capable of interacting with other applications over a method of communication, such as the internet. Web services are typically based on standards or protocols such as XML, SOAP, AJAX, WSDL and UDDI. Web services methods are well known in the art, and are covered in many standard texts.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the Internet server. Middleware may be configured to process transactions between the various components of an application server and any number of internal or external systems for any of the purposes disclosed herein. WEBSPHERE MQTM (formerly MQSeries) by IBM®, Inc. (Armonk, N.Y.) is an example of a commercially available middleware product. An Enterprise Service Bus (“ESB”) application is another example of middleware.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, JAVA®, JAVASCRIPT, VBScript, Macromedia Cold Fusion, COBOL, MICROSOFT® Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JAVASCRIPT, VBScript or the like. For a basic introduction of cryptography and network security.

As used herein, the term “end user”, “consumer”, “customer”, “cardmember”, “business” “merchant”, or “program administrator” may be used interchangeably with each other, and each shall mean any person, entity, government organization, business, machine, hardware, and/or software. A bank may be part of the system, but the bank may represent other types of card issuing institutions, such as credit card companies, card sponsoring companies, or third party issuers under contract with financial institutions. It is further noted that other participants may be involved in some phases of the transaction, such as an intermediary settlement institution, but these participants are not shown.

Each participant is equipped with a computing device in order to interact with the system and facilitate online commerce transactions. The customer has a computing unit in the form of a personal computer, although other types of computing units may be used including laptops, notebooks, hand held computers, set-top boxes, cellular telephones, touch-tone telephones and the like. The merchant has a computing unit implemented in the form of a computer-server, although other implementations are contemplated by the system. The bank has a computing center shown as a main frame computer. However, the bank computing center may be implemented in other forms, such as a mini-computer, a PC server, a network of computers located in the same of different geographic locations, or the like. Moreover, the system contemplates the use, sale or distribution of any goods, services or information over any network having similar functionality described herein

The merchant computer and the bank computer may be interconnected via a second network, referred to as a payment network. The payment network which may be part of certain transactions represents existing proprietary networks that presently accommodate transactions for credit cards, debit cards, and other types of financial/banking cards. The payment network is a closed network that is assumed to be secure from eavesdroppers. Exemplary transaction networks may include the American Express®, VisaNet® and the Veriphone® networks.

The electronic commerce system may be implemented at the customer and issuing bank. In an exemplary implementation, the electronic commerce system is implemented as computer software modules loaded onto the customer computer and the banking computing center. The merchant computer does not require any additional software to participate in the online commerce transactions supported by the online commerce system.

Phrases and terms similar to an “entity” may include any individual, consumer, customer, group, business, organization, government entity, transaction account issuer or processor (e.g., credit, charge, etc), merchant, consortium of merchants, account holder, charitable organization, software, hardware, and/or any other type of entity. The terms “user,” “consumer,” “purchaser,” and/or the plural form of these terms are used interchangeably throughout herein to refer to those persons or entities that are alleged to be authorized to use a transaction account.

Phrases and terms similar to “account”, “account number”, “account code” or “consumer account” as used herein, may include any device, code (e.g., one or more of an authorization/access code, personal identification number (“PIN”), Internet code, other identification code, and/or the like), number, letter, symbol, digital certificate, smart chip, digital signal, analog signal, biometric or other identifier/indicia suitably configured to allow the consumer to access, interact with or communicate with the system. The account number may optionally be located on or associated with a rewards account, charge account, transaction account, debit account, prepaid account, telephone card, embossed card, smart card, magnetic stripe card, bar code card, transponder, radio frequency card or an associated account.

The account number may be distributed and stored in any form of plastic, electronic, magnetic, radio frequency, wireless, audio and/or optical device capable of transmitting or downloading data from itself to a second device. A consumer account number may be, for example, a sixteen-digit account number, although each credit provider has its own numbering system, such as the fifteen-digit numbering system used by American Express. Each company's account numbers comply with that company's standardized format such that the company using a fifteen-digit format will generally use three-spaced sets of numbers, as represented by the number “0000 000000 00000”. The first five to seven digits are reserved for processing purposes and identify the issuing bank, account type, etc. In this example, the last (fifteenth) digit is used as a sum check for the fifteen digit number. The intermediary eight-to-eleven digits are used to uniquely identify the consumer. A merchant account number may be, for example, any number or alpha-numeric characters that identify a particular merchant for purposes of account acceptance, account reconciliation, reporting, or the like.

In various embodiments, an account number may identify a consumer. In addition, in various embodiments, a consumer may be identified by a variety of identifiers, including, for example, an email address, a telephone number, a cookie id, a radio frequency identifier (RFID), a biometric, and the like.

Phrases and terms similar to “transaction account” may include any account that may be used to facilitate a financial transaction. Phrases and terms similar to “financial institution” or “transaction account issuer” may include any entity that offers transaction account services. Although often referred to as a “financial institution,” the financial institution may represent any type of bank, lender or other type of account issuing institution, such as credit card companies, card sponsoring companies, or third party issuers under contract with financial institutions. It is further noted that other participants may be involved in some phases of the transaction, such as an intermediary settlement institution.

As will be appreciated by one of ordinary skill in the art, the system may be embodied as a customization of an existing system, an add-on product, a processing apparatus executing upgraded software, a standalone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

Referring now to FIGS. 2A-5C the process flows and screenshots depicted are merely embodiments and are not intended to limit the scope of the disclosure. For example, the steps recited in any of the method or process descriptions may be executed in any order and are not limited to the order presented. It will be appreciated that the following description makes appropriate references not only to the steps and user interface elements depicted in FIGS. 2A-5C, but also to the various system components as described above with reference to FIG. 1.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user WINDOWS®, webpages, websites, web forms, prompts, etc. Practitioners will appreciate that the illustrated steps described herein may comprise in any number of configurations including the use of WINDOWS®, webpages, web forms, popup WINDOWS®, prompts and the like. It should be further appreciated that the multiple steps as illustrated and described may be combined into single webpages and/or WINDOWS® but have been expanded for the sake of simplicity. In other cases, steps illustrated and described as single process steps may be separated into multiple webpages and/or WINDOWS® but have been combined for simplicity.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described various embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112 (f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A non-transitory computer-readable medium embodying a plurality of computer instructions executable in at least one computing device, the plurality of computer instructions being configured to cause the at least one computing device to at least:
obtain a request to generate a virtual record account link to a parent record account;
assign a pre-authorized use to the virtual record account, the pre-authorized use comprising a limited use relative to the parent record account;
generate, in response to at least obtaining the request, a token for a mobile application, the token incorporating the limited use relative to the parent record account;
link the token for the mobile application to the parent record account; and
transmit the token to a mobile device to create a mechanism for the virtual record account in the mobile device, wherein the token comprises the mechanism utilized by the mobile application stored on the mobile computing device.

2. The non-transitory computer-readable medium of claim 1, wherein the plurality of computer instructions are further configured to cause the at least one computing device to at least:
obtain information indicating use of the mechanism for a mobile record; and
associate, in response to obtaining the information indicating use of the mechanism for the mobile record, the mobile record with the parent record account.

3. The non-transitory computer-readable medium of claim 1, wherein the plurality of computer instructions are further configured to cause the at least one computing device to at least generate a record report comprising data corresponding to a record associated with the mechanism.

4. The non-transitory computer-readable medium of claim 1, wherein the plurality of computer instructions are further configured to cause the at least one computing device to at least link an instance of the mobile application installed on the mobile device with a designated recipient of the token for the mobile application.

5. The non-transitory computer-readable medium of claim 1 wherein the plurality of computer instructions are further configured to cause that least one computing device to at least determine a record limit for the virtual record account.

6. The non-transitory computer-readable medium of claim 1 wherein the plurality of computer instructions are further configured to cause the at least one computing device to at least:
authenticate the request to generate the virtual record account; and
determine that generating the token for the mobile application is authorized.

7. A method, comprising:
obtaining, by at least one computing device, a request to generate a virtual record account link to a parent record account;
assigning, by the at least one computing device, a pre-authorized use to the virtual record account, the pre-authorized use comprising a limited use relative to the parent record account;
generating, by the at least one computing device, in response to at least obtaining the request, a token for a mobile application, the token incorporating the limited use relative to the parent record account;
linking, by the at least one computing device, the token for the mobile application to the parent record account; and
transmitting, from the at least one computing device, the token to a mobile device to create a mechanism for the virtual record account in the mobile device, wherein the token comprises the mechanism utilized by the mobile application stored on the mobile computing device.

8. The method of claim 7, further comprising:
obtaining, by the at least one computing device, information indicating use of the mechanism for a mobile record; and
associating, by the at least one computing device, in response to obtaining the information indicating use of the mechanism for the mobile record, the mobile record with the parent record account.

9. The method of claim 7, further comprising generating, by the at least one computing device, a record report comprising data corresponding to a record associated with the mechanism.

10. The method of claim 7, further comprising linking, by the at least one computing device, an instance of the mobile application installed on the mobile device with a designated recipient of the token for the mobile application.

11. The method of claim 7, further comprising determining, by the at least one computing device, a record limit for the virtual record account.

12. The method of claim 7, further comprising authenticating, by the at least one computing device, the request to generate the virtual record account.

13. The method of claim 7, further comprising determining, by the at least one computing device, that generating the token for the mobile application is authorized.

14. A system, comprising:
at least one computing device;
a computer-readable medium in communication with the at least one computing device, the computer-readable medium embodying a plurality of computer instructions that, when executed by the at least one computing device, cause the at least one computing device to at least:
obtain a request to generate a virtual record account link to a parent record account;
assign a pre-authorized use to the virtual record account, the pre-authorized use comprising a limited use relative to the parent record account;
generate, in response to at least obtaining the request, a token for a mobile application, the token incorporating the limited use relative to the parent record account;
link the token for the mobile application to the parent record account; and
transmit the token to a mobile device to create a mechanism for the virtual record account in the mobile device, wherein the token comprises the mechanism utilized by the mobile application stored on the mobile computing device.

15. The system of claim 14, wherein the plurality of computer instructions are further configured to cause the at least one computing device to at least:
obtain information indicating use of the mechanism for a mobile record; and
associate, in response to obtaining the information indicating use of the mechanism for the mobile record, the mobile record with the parent record account.

16. The system of claim 14, wherein the plurality of computer instructions are further configured to cause the at least one computing device to at least generate a record report comprising data corresponding to a record associated with the mechanism.

17. The system of claim 14, wherein the plurality of computer instructions are further configured to cause the at least one computing device to at least link an instance of the mobile application installed on the mobile device with a designated recipient of the token for the mobile application.

18. The system of claim 14 wherein the plurality of computer instructions are further configured to cause that least one computing device to at least determine a record limit for the virtual record account.

19. The system of claim 14 wherein the plurality of computer instructions are further configured to cause the at least one computing device to at least authenticate the request to generate the virtual record account.

20. The system of claim 14 wherein the plurality of computer instructions are further configured to cause the at least determine that generating the token for the mobile application is authorized.
